(19) United States
(12) Patent Application Publication
(10) Pub. No.: US 2011/0211038 A1
(43) Pub. Date: Sep. 1, 2011

(54) IMAGE COMPOSING APPARATUS

(75) Inventors: Kiyoshi NOGUCHI, Daito-shi (JP); Akira TOBA, Osaka-shi (JP)

(73) Assignee: SANYO ELECTRIC CO., LTD., Moriguchi-Shi (JP)

(21) Appl. No.: 13/029,590

(22) Filed: Feb. 17, 2011

(30) Foreign Application Priority Data
Mar. 1, 2010 (JP) 2010-043762

(51) Int. Cl. H04N 5/228

(52) U.S. Cl. 348/36; 348/E05.031

(57) ABSTRACT

An image composing apparatus includes a first accumulator which repeatedly accumulates a moving amount of an imaging surface in one of a horizontal direction and a vertical direction. A first determiner repeatedly determines whether or not a movement of the imaging surface in another of the horizontal direction and the vertical direction satisfies a taking condition, in a period during which an accumulated value of the first accumulator belongs to a predetermined range. A second determiner repeatedly determines whether or not the accumulated value of the first accumulator reaches an upper limit of the predetermined range. A taker takes, for image composing, a scene image produced on the imaging surface corresponding to updating from a negative result to a positive result on a determined result of the first determiner and/or the second determiner. A restarter restarts the first accumulator in association with a taking process of the taker.

### CROSS REFERENCE OF RELATED APPLICATION

The disclosure of Japanese Patent Application No. 2010-43762, which was filed on Mar. 1, 2010, is incorporated herein by reference.

### BACKGROUND OF THE INVENTION

1. Field of the Invention

The present invention relates to an image composing apparatus. More particularly, the present invention relates to an image composing apparatus which is applied to a digital camera having a panorama mode, and composes a plurality of scene image in a manner to be partially overlapped.

2. Description of the Related Art

According to one example of this type of apparatus, a movement amount of an imaging surface is detected based on outputs of a gyro unit and a GPS unit. With reference to the detected moving amount, a plurality of images used for creating a panorama image is photographed at a timing of moderate overlapping being produced among the images. A blurring amount of an imaging surface in a vertical direction is repeatedly detected in parallel with the photographing process, and a warning is generated when the detected blurring amount exceeds a threshold value.

However, a countermeasure to inhibit blurring on the imaging surface in the vertical direction remains at generation of the warning. Thus, operability is limited in the above-described apparatus.

### SUMMARY OF THE INVENTION

According to the present invention, an image composing apparatus, comprises: a first accumulator which repeatedly accumulates a moving amount of an imaging surface in one direction of a horizontal direction and a vertical direction; a first determiner which repeatedly determines whether or not a movement of the imaging surface in another direction of the horizontal direction and the vertical direction satisfies a taking condition, in a period during which an accumulated value of the first accumulator belongs to a predetermined range; a second determiner which repeatedly determines whether or not the accumulated value of the first accumulator reaches an upper limit of the predetermined range, in parallel with a determining process of the first determiner; a taker which takes, for image composing, a scene image produced on the imaging surface corresponding to updating from a negative result to a positive result on a determined result of the first determiner and/or a determined result of the second determiner; and a restarter which restarts the first accumulator in association with a taking process of the taker.

According to the present invention, a computer program embodied in a tangible medium which is executed by a processor of an image composing apparatus, comprises: an accumulating instruction to repeatedly accumulate a moving amount of an imaging surface in one direction of a horizontal direction and a vertical direction; a first determining instruction to repeatedly determine whether or not a movement of the imaging surface in another direction of the horizontal direction and the vertical direction satisfies a taking condition, in a period during which an accumulated value based on the accumulating instruction belongs to a predetermined range; a second determining instruction to repeatedly determine whether or not the accumulated value based on the accumulating instruction reaches an upper limit of the predetermined range, in parallel with a determining process based on the first determining instruction; a taking instruction to take, for image composing, a scene image produced on the imaging surface corresponding to updating from a negative result to a positive result on a determined result based on the first determining instruction and/or a determined result based on the second determining instruction; and a restarting instruction to restart the first accumulator in association with a taking process based on the taking instruction.

According to the present invention, an image composing method which is executed by an image composing apparatus, comprises: a first accumulating step of repeatedly accumulating a moving amount of an imaging surface in one direction of a horizontal direction and a vertical direction; a first determining step of repeatedly determining whether or not a movement of the imaging surface in another direction of the horizontal direction and the vertical direction satisfies a taking condition, in a period during which an accumulated value based on the first accumulator belongs to a predetermined range; a second determining step of repeatedly determining whether or not the accumulated value based on the accumulating step reaches an upper limit of the predetermined range, in parallel with a determining process based on the first determining step; a taking step of taking, for image composing, a scene image produced on the imaging surface corresponding to updating from a negative result to a positive result on a determined result based on the first determining step and/or a determined result based on the second determining step; and a restarting step of restarting the accumulating step in association with a taking process based on the taking step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of an allocation state of a photometric area and a focus area;

FIG. 4 is an illustrative view showing one example of a scene image captured with a panorama mode;

FIG. 5 is an illustrative view showing one example of cut-out behavior of strip image data ST_0;

FIG. 6 (A) is an illustrative view showing one example of an execution timing of a still-image taking process;

FIG. 6 (B) is an illustrative view showing another example of the execution timing of the still-image taking process;

FIG. 7 is an illustrative view showing one example of a configuration of a register applied to the embodiment in FIG. 2;

FIG. 8 is an illustrative view showing one example of cut-out behavior of strip image data ST_2 and ST_3;

FIG. 9 is an illustrative view showing one example of a distribution state of a scene captured at a time point at which the still-image taking process is executed;

FIG. 10 is an illustrative view showing one example of cut-out behavior of strip image data ST_4;

FIG. 11 is an illustrative view showing one portion of an image composing process;

FIG. 12 is an illustrative view showing another portion of the image composing process;

FIG. 13 is an illustrative view showing one example of panorama image data created by the image composing process;

FIG. 14 is a flowchart showing one portion of behavior of a CPU applied to the embodiment in FIG. 2;

FIG. 15 is a flowchart showing another portion of behavior of the CPU applied to the embodiment in FIG. 2;

FIG. 16 is a flowchart showing still another portion of behavior of the CPU applied to the embodiment in FIG. 2;

FIG. 17 is a flowchart showing yet another portion of behavior of the CPU applied to the embodiment in FIG. 2; and

FIG. 18 is a flowchart showing another portion of behavior of the CPU applied to the embodiment in FIG. 2.

### DETAILED DESCRIPTION OF THE PREFERRED EMBODIMENTS

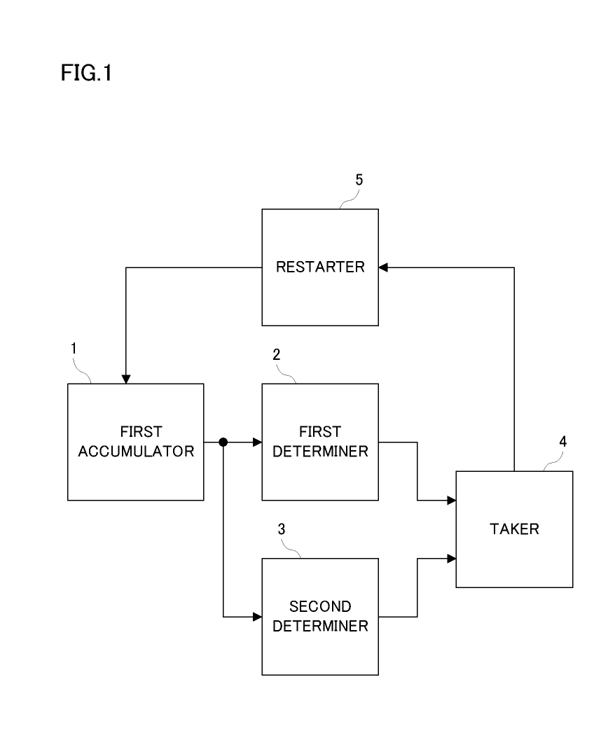

With reference to FIG. 1, an image composing apparatus of one embodiment of the present invention is basically configured as follows: A first accumulator 1 repeatedly accumulates a moving amount of an imaging surface in one direction of a horizontal direction and a vertical direction. A first determiner 2 repeatedly determines whether or not a movement of the imaging surface in another direction of the horizontal direction and the vertical direction satisfies a taking condition, in a period during which an accumulated value of the first accumulator 1 belongs to a predetermined range. A second determiner 3 repeatedly determines whether or not the accumulated value of the first accumulator 1 reaches an upper limit of the predetermined range, in parallel with a determining process of the first determiner 2. A taker 4 takes, for image composing, a scene image produced on the imaging surface corresponding to updating from a negative result to a positive result on a determined result of the first determiner 2 and/or a determined result of the second determiner 3. A restarter 5 restarts the first accumulator 1 in association with a taking process of the taker 4.

In a case where one direction of the horizontal direction and the vertical direction is defined as a first direction, and another direction of the horizontal direction and the vertical direction is defined as a second direction, the taking process of the scene image is executed when the movement of the imaging surface in the second direction satisfies the taking condition in the period during which the accumulated value of the moving amount of the imaging surface in the first direction belongs the predetermined range, or the accumulated value of the moving amount of the imaging surface in the first direction reaches the upper limit of the predetermined range.

By executing the taking process when the movement of the imaging surface in the second direction satisfies the taking condition in the period during which the accumulated value of the moving amount of the imaging surface in the first direction belongs the predetermined range, it becomes possible to inhibit blurring of the scene image in the second direction. Moreover, by executing the taking process when the accumulated value of the moving amount of the imaging surface in the first direction reaches the upper limit of the predetermined range, it becomes possible to ensure continuity of a composed image in the first direction. Thus, operability regarding creating the composed image is improved.

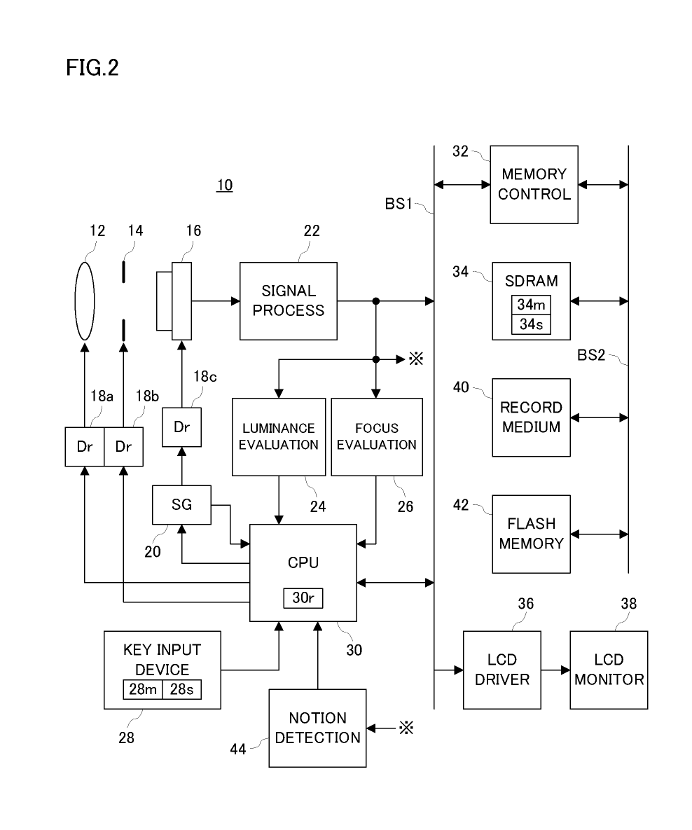

With reference to FIG. 2, a digital camera 10 according to this embodiment includes a focus lens 12 and an aperture unit 14 respectively driven by drivers 18a and 18b. An optical image of a scene that undergoes the focus lens 12 and the aperture unit 14 enters, with irradiation, the imaging surface of an imaging device 16, and is subjected to a photoelectric conversion. Thereby, electric charges representing the scene image are produced.

When a power source is applied, a CPU 30 commands a driver 18c to repeat an exposure procedure and an electric-charge reading-out procedure in order to start a through-image process. In response to a vertical synchronization signal Vsync cyclically generated from an SG (Signal Generator) 20, the driver 18c performs pre-exposure on the imaging surface and also reads out the electric charges produced thereby in a raster-scanning manner. From the imaging device 16, raw image data based on the read-out electric charges are cyclically outputted.

A signal processing circuit 22 performs processes, such as white balance adjustment, color separation, YUV conversion, on the raw image data outputted from the imaging device 16, and applies YUV formatted-image data created thereby to a memory control circuit 32 through a bus BS1. The memory control circuit 32 writes the applied image data into a moving-image area 34m of an SDRAM 34 through a bus BS2.

The image data accommodated in the moving-image area 34m is repeatedly read out by the memory control circuit 32, and is applied to an LCD driver 36 through the bus BS1. The LCD driver 36 drives an LCD monitor 38 based on the applied image data. As a result, a real-time moving image (through image) of the scene is displayed on a monitor screen.

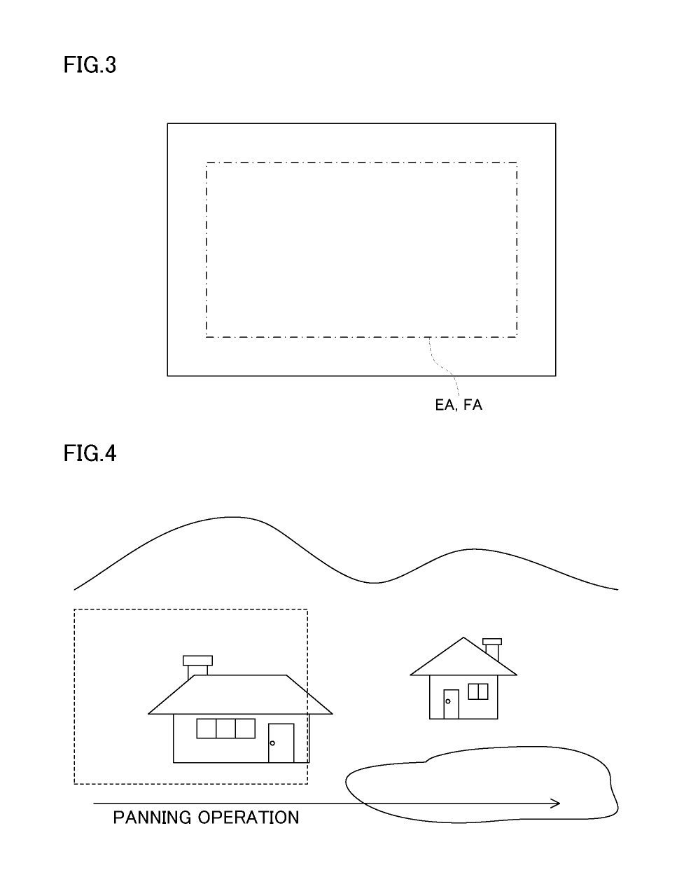

With reference to FIG. 3, a photometric area EA is allocated to the center of the imaging surface. A luminance evaluating circuit 24 integrates Y data belonging to the photometric area EA, out of the Y data outputted from the signal processing circuit 22, at each generation of the vertical synchronization signal Vsync. An integral value, i.e., a luminance evaluation value, is outputted from the luminance evaluating circuit 24 in a generation cycle of the vertical synchronization signal Vsync. The CPU 30 repeatedly executes a simple AE process in order to calculate an appropriate EV value based on the luminance evaluation value outputted from the luminance evaluating circuit 24. An aperture amount and an exposure time period, which define the calculated appropriate EV value, are respectively set to the drivers 18b and 18c. As a result, brightness of the through image displayed on the LCD monitor 38 is moderately adjusted.

When a shutter button 28s on a key input device 28 is half-depressed, a strict AE process is executed in order to calculate an optimal EV value based on the luminance evaluation value outputted from the luminance evaluating circuit 24. An aperture amount and an exposure time period, which define the calculated optimal EV value, are respectively set to the drivers 18b and 18c similar to the above-described case.

Upon completion of the strict AE process, an AF process based on output of a focus evaluating circuit 26 is executed. The focus evaluating circuit 26 integrates a high-frequency component of Y data belonging to a focus area FA (see FIG. 3), out of the Y data outputted from the signal processing circuit 22, at each generation of the vertical synchronization signal Vsync. An integral value, i.e., an AF evaluation value, is outputted from the focus evaluating circuit 26 in a generation cycle of the vertical synchronization signal Vsync.

The CPU 30 takes the AF evaluation value from the focus evaluating circuit 26 so as to search a focal point by a so-called hill-climbing process. The focus lens 12 is moved in an optical-axis direction at each generation of the vertical synchronization signal Vsync, and thereafter placed at the focal point.

When the shutter button 28s is fully depressed, the CPU 30 applies a corresponding command to the memory control circuit 32 in order to execute a still-image taking process. The memory control circuit 32 duplicates one frame of the image data representing the scene at a time point at which the shutter button 28s is fully depressed, from the moving-image area 34m to a still-image area 34s.

An imaging mode is set to any one of a normal mode and a panorama mode by an operation of a mode key 28m prior to an operation of the shutter button 28s. When the set imaging mode is the normal mode, the CPU 30 applies a corresponding command to the memory control circuit 32 in order to execute a recording process. The memory control circuit 32 reads out one frame of the image data duplicated by the still-image taking process from the still-image area 34s so as to record the read-out image data on a recording medium 40 in a file format. Upon completion of the recording process, the above-described through-image process and the simple AE process are resumed.

When the imaging mode set by the operation of the mode key 28m is the panorama mode, following processes are executed by the CPU 30 in order to create panorama image data.

Firstly, variables K and Hw_K are respectively set to “0” and “Hth1”. Herein, the variable K is equivalent to a frame number which is allocated to the image data duplicated in the still-image area 34s. Moreover, the variable Hw_K is equivalent to a coefficient which defines a width of strip image data ST_K cut out from K-th frame of image data. Furthermore, “Hth1” is one of threshold values which are referred to in order to control a future timing of executing the still-image taking process.

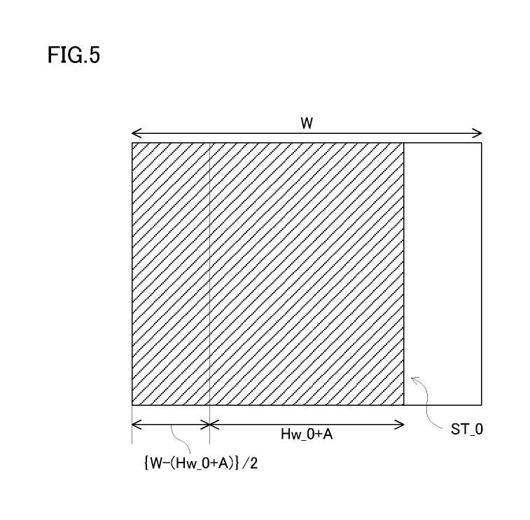

When the variables K and Hw_K are determined, the strip image data ST_K is cut out from the K-th frame of image data duplicated in the still-image area 34s. With regard to K=0, a cut-out position is set to the left end, and a cut-out width is set to “Hw_K+A+{W−(Hw_K+A)}/2”. As a result, strip image data ST_0 is cut out as shown in FIG. 5.

Upon completion of cutting out the strip image data ST_K, accumulation motion vectors Vttl and Httl are set to “0”, and the variable K is incremented. Herein, the accumulation motion vector Vttl indicates an accumulated value of a motion vector of the imaging surface in the vertical direction, and the accumulation motion vector Httl indicates an accumulated value of the motion vector of the imaging surface in the horizontal direction.

A motion detecting circuit 44 shown in FIG. 2 repeatedly detects the motion vector of the imaging surface based on the Y data outputted from the signal processing circuit 22. The detected motion vector is taken by the CPU 30 at each generation of the vertical synchronization signal Vsync.

A horizontal component of the taken motion vector is extracted as a horizontal motion vector Hvct, and the extracted horizontal motion vector Hvct is accumulated on the accumulation motion vector Httl. Moreover, a vertical component of the taken motion vector is extracted as a vertical motion vector Vvct, and the extracted vertical motion vector Vvct is accumulated on the accumulation motion vector Vttl.

An absolute value of the accumulation motion vector Vttl is compared with each of threshold values Vth1 and Vth2, and the accumulation motion vector Httl is compared with each of threshold values Hth1 and Hth2. Herein, the threshold value Hth2 is greater than the threshold value Hth1, and the threshold value Vth2 is greater than the threshold value Vth1. More specifically, the threshold value Hth1 is equivalent to 10 percent of a horizontal angle of view, and the threshold value Hth2 is equivalent to 30 percent of the horizontal angle of view. Furthermore, the threshold value Vth1 is equivalent to 5 percent of a vertical angle of view, and the threshold value Vth2 is equivalent to 200 percent of the vertical angle of view.

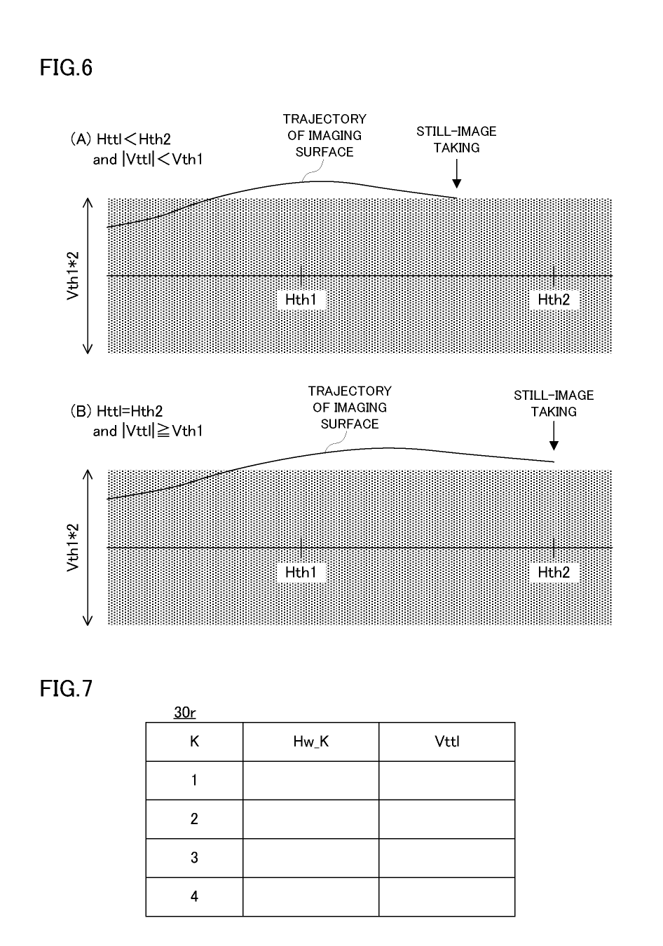

When the absolute value of the accumulation motion vector Vttl falls below the threshold value Vth1 in a period during which the accumulation motion vector Httl belongs a predetermined range(=a range from the threshold value Hth1 to the threshold value Hth2), the still-image taking process is executed at the time point (see FIG. 6(A)).

Furthermore, the absolute value of the accumulation motion vector Vttl maintains a value which is equal to or more than the threshold value Vth1 and less than the threshold value Vth2 during a time period in which the accumulation motion vector Httl belongs to the predetermined range, the still-image taking process is executed at a time point at which the accumulation motion vector Httl has reached the threshold value Hth2.

As a result of the still-image taking process having been executed, the Kth frame of image data is duplicated from the moving-image area 34m to the still-image area 34s. Subsequently, the accumulation motion vector Httl is set to the variable Hw_K, and the variable Hw_K and the accumulation motion vector Vttl are set to a Kth column of a register 30r shown in FIG. 7.

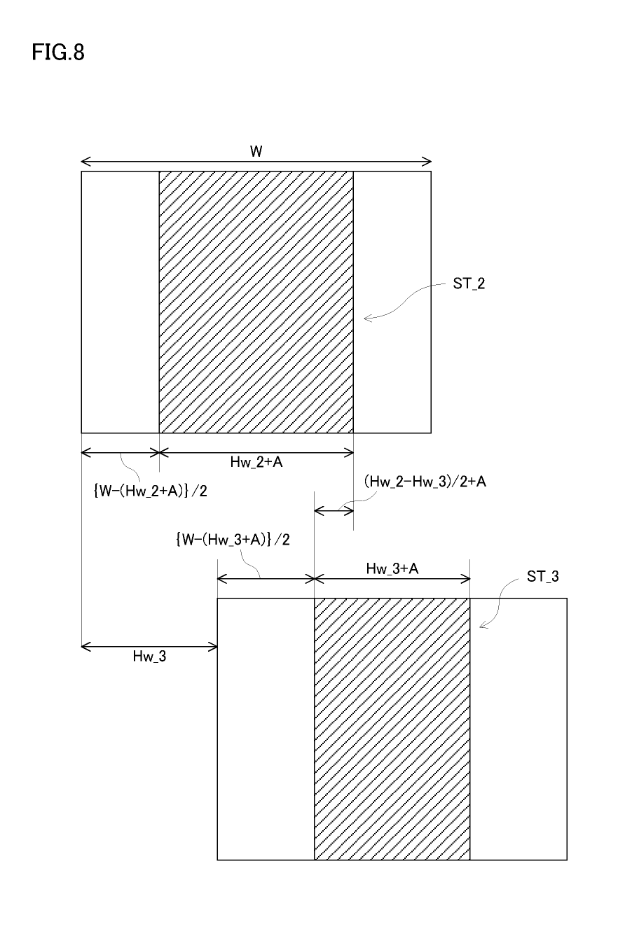

If the variable K is less than “4”, the strip image data ST_K is cut out from the Kth frame of image data which is duplicated in the still-image area 34s. With regard to K=1 to 3, the cut-out position is set to the center, and the cut-out width is set to “Hw_K+A”. As a result, the strip image data ST_2 and ST_3 are cut out in such a manner as shown in FIG. 8. As understood from FIG. 8, a margin having a width which is equivalent to “(Hw_2−Hw_3)/2+A” is secured between the cut out strip image data ST_2 and ST_1

Upon completion of cutting out the strip image data ST_K, the accumulation motion vector Httl is set to “0”, and the variable K is incremented. A timing of executing the still-image taking process for the next frame is controlled based on the accumulated value of the horizontal motion vector Hvct which is detected thereafter.

With referring to FIG. 9, in a case where the shutter button 28s is fully depressed corresponding to a frame F_0, and thereafter the imaging surface is moved in the horizontal direction with slightly moving in the vertical direction, the still-image taking process for a first frame is executed corresponding to a frame F_1, the still-image taking process for a second frame is executed corresponding to a frame F_2, the still-image taking process for a third frame is executed corresponding to a frame F_3, and the still-image taking process for a fourth frame is executed corresponding to a frame F_4.

According to FIG. 9, the still-image taking process for the first frame is executed at a time point at which the accumulation motion vector Httl has reached the upper limit (=Hth2) of the predetermined range. At this time, the accumulation motion vector Vttl indicates a value which is equal to or more than the absolute value of the threshold value Vth1. The still-image taking process for the second frame is executed at a time point at which the accumulation motion vector Vttl falls below the threshold value Vth1 in a period during which the accumulation motion vector Httl belongs the predetermined range.

The still-image taking process for the third frame is executed at a time point at which the accumulation motion vector Httl has reached the upper limit (=Hth2) of the predetermined range. At this time, the accumulation motion vector Vttl indicates a value which is equal to or more than the absolute value of the threshold value Vth1. The still-image taking process for the fourth frame is executed at a time point at which the accumulation motion vector Vttl falls below the threshold value Vth1 in a period during which the accumulation motion vector Httl belongs the predetermined range.

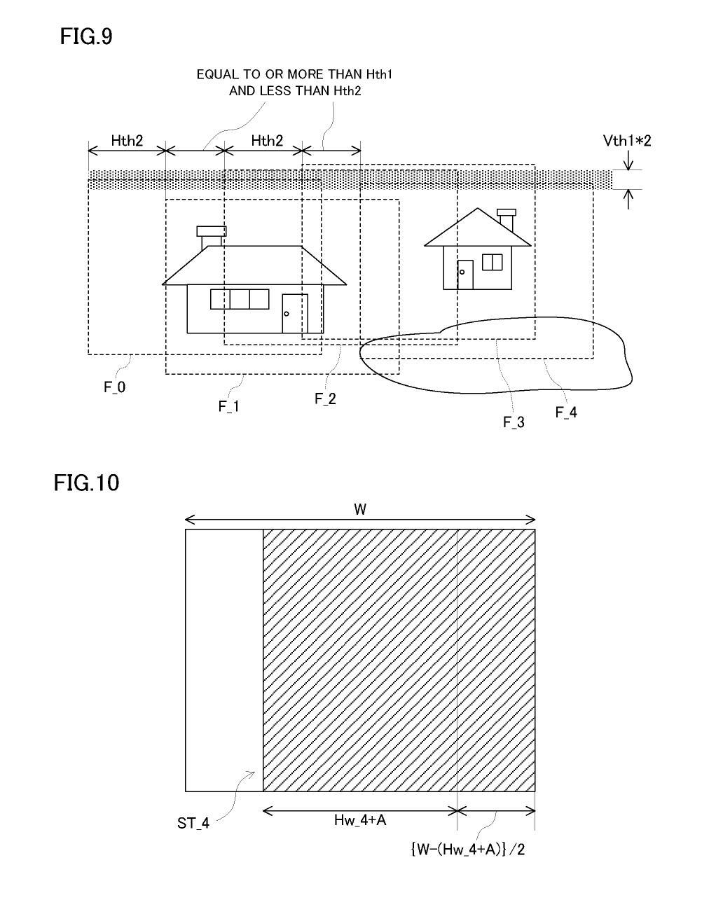

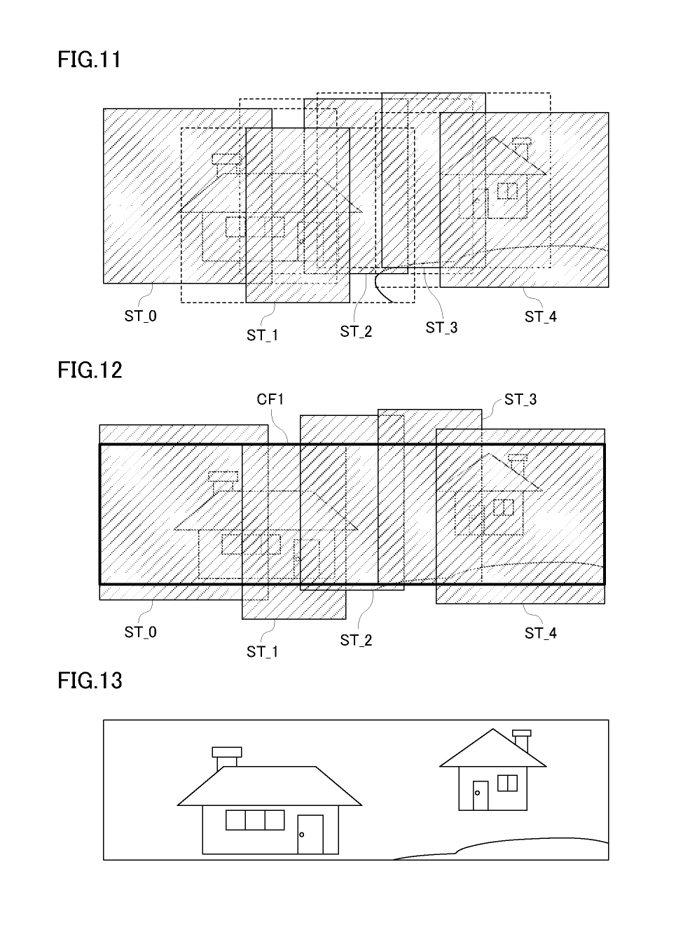

Even when the variable K has reached “4”, the strip image data ST_K is cut out from the Kth frame of image data which is duplicated in the still-image area 34s. However, with regard to K=4, the cut-out position is set to the right end, and the cut-out width is set to “Hw_K+A+{W−(Hw_K+A)}/2”. Consequently, strip image data ST_4 is cut out in such a manner as shown in FIG. 10.

Upon completion of cutting out the strip image data ST_4, a panorama image creating process is executed. The cut out strip image data ST_0 to ST_4 are composed in such a manner as shown in FIG. 11, in reference to the variables Hw_1 to Hw_4 and four accumulation motion vectors Vttls which are registered in the register 30r. A cut out frame CF1 is defined on the composed image data as shown in FIG. 12, and a partial image data is cut out along the cut out frame CF1. As a result, panorama image data shown in FIG. 13 is obtained. Thus created panorama image data is thereafter recorded in the recording medium 40 in a file format.

It is noted that when the accumulation motion vector Vttl reaches the threshold value Vth2, a process which is similar to the above described panorama image creating process is executed in a case where the variable K is equal to or more than “1”, that is, at least two frames of the image data are duplicated in the still-image area 34s. Panorama image data created thereby is also recorded in the recording medium 40 in a file format. It is noted that when the accumulation motion vector Vttl reaches the threshold value Vth2 in a state where the variable K indicates “0”, an error process is executed.

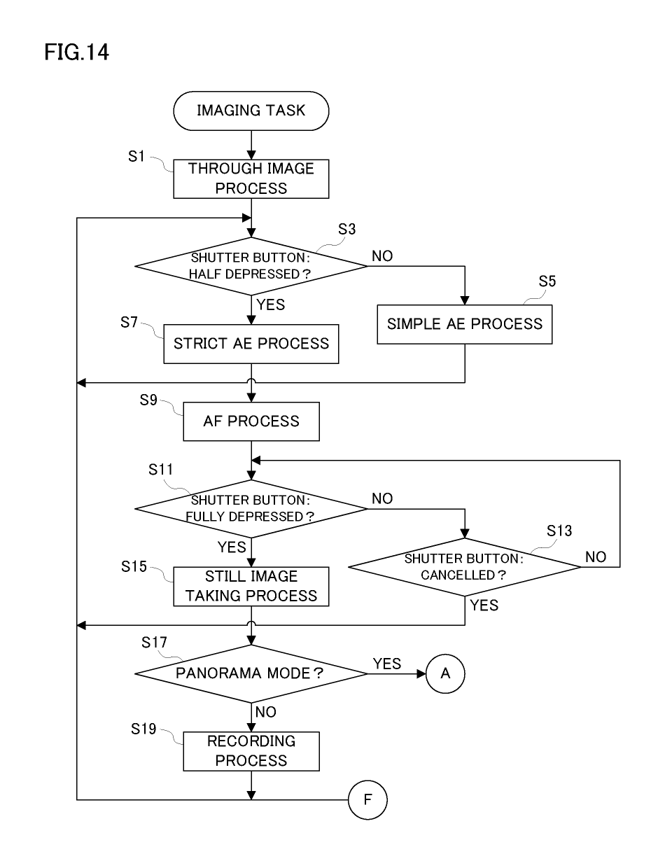

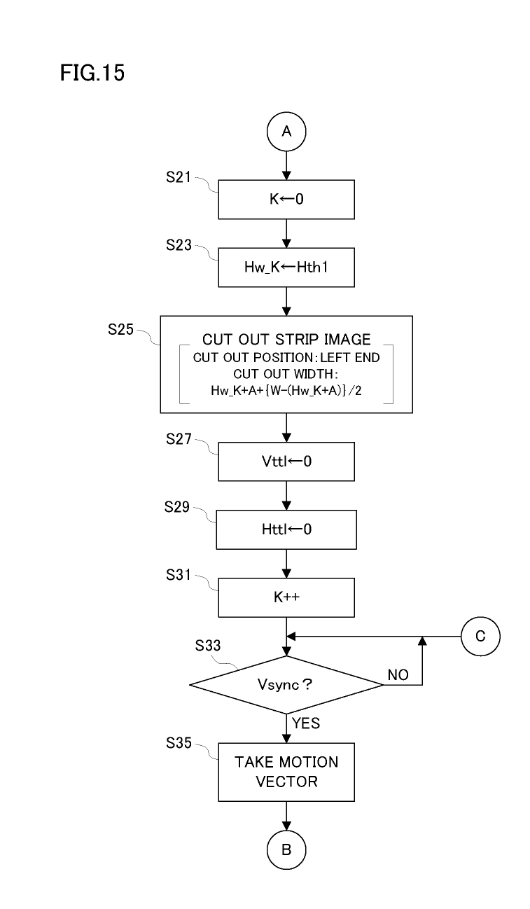

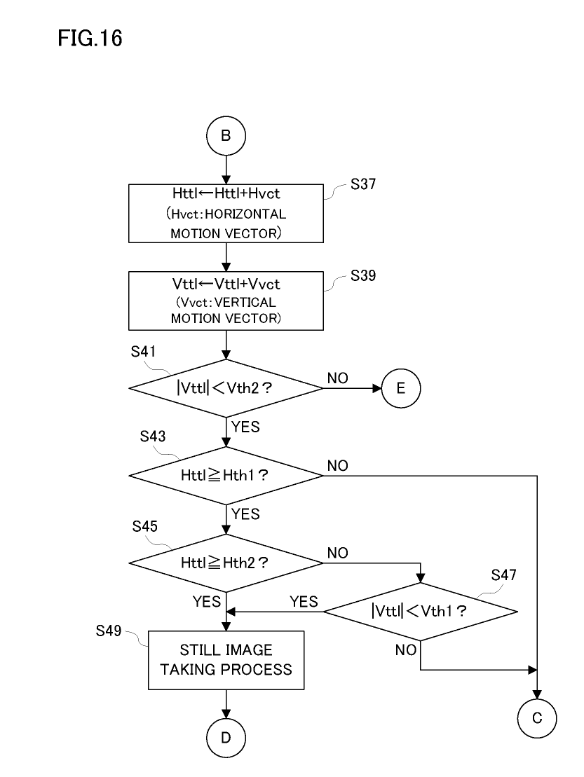

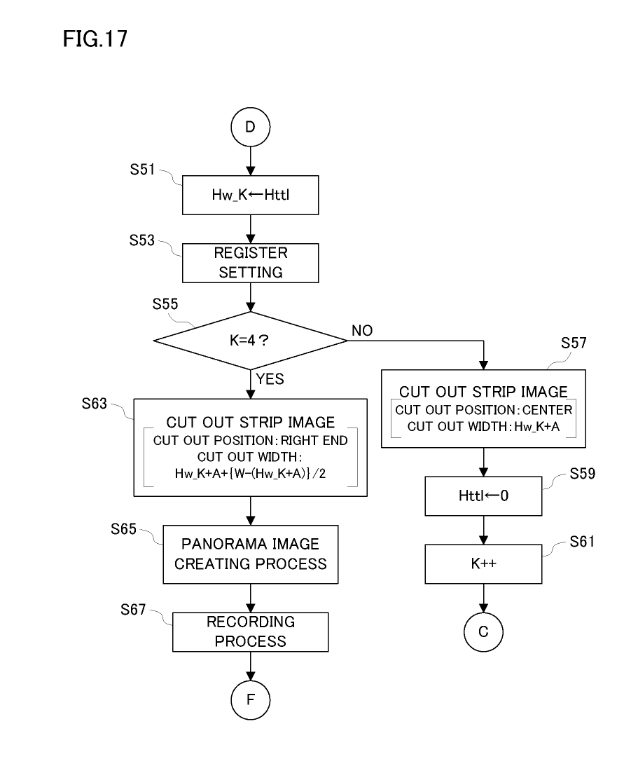

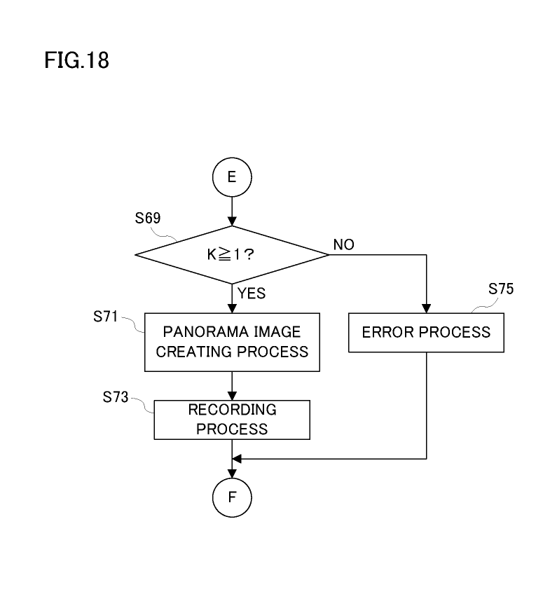

The CPU 30 executes processes according to an imaging task shown in FIG. 14 to FIG. 18. A control program corresponding to the imaging task is memorized in a flash memory 42.

With reference to FIG. 14, the through-image process is executed in a step S1. As a result, image data representing a scene is repeatedly written into the moving-image area 34m, and a through image based thereon is displayed on the LCD monitor 38. In a step S3, it is determined whether or not the shutter button 28s is half-depressed, and as long as a determined result is NO, the simple AE process in a step S5 is repeated. As a result, a brightness of the through image is moderately adjusted. When the shutter button 28s is half-depressed, the strict AE process is executed in a step S7, and the AF process is executed in a step S9. The brightness of the through image is adjusted to an optimal value by the process of the step S7, and the focus lens 12 is placed at a focal point by the process of the step S9.

In a step S11, it is determined whether or not the shutter button 28s is fully depressed, and in a step S13, it is determined whether or not an operation of the shutter button 28s is cancelled. When YES is determined in the step S13, the process returns to the step S3, and when YES is determined in the step S11, the still-image taking process is executed in a step S15. As a result of the process in the step S15, one frame of image data at a time point at which the shutter button 28s is fully depressed is duplicated from the moving-image area 34m to the still-image area 34s.

In a step S17, it is determined whether a current imaging mode is the normal mode or the panorama mode. If the current imaging mode is the normal mode, the process advances from the step S17 to a step S19 in order to execute the recording process. As a result, one frame of image data duplicated in the still-image area 34s is recorded to the recording medium 40 in a file format. Upon completion of the recording process, the process returns to the step S1.

The current imaging mode is the panorama mode, YES is determined in the step S17, and therefore, the variable K is set to “0” in a step S21, and the variable Hw_K is set to “Hth1” in a step S23. In a step S25, the strip image data ST_K is cut out from the Kth frame of image data which is duplicated in the still-image area 34s. At this time, the cut-out position is set to the left end, and the cut-out width is set to “Hw_K+A+{W−(Hw_K+A)}/2”.

In a step S27, the accumulation motion vector Vttl is set to “0”, and in a step S29, the accumulation motion vector Httl is set to “0”. In a step S31, the variable K is incremented, and in a step S33, it is determined whether or not the vertical synchronization signal Vsync is generated. When a determined result is updated from NO to YES, a motion vector created by the motion detecting circuit 44 is taken in a step S35. In a step S37, a horizontal component of the taken motion vector is extracted as the horizontal motion vector Hvct, and the extracted horizontal motion vector Hvct is accumulated on the accumulation motion vector Httl. In a step S39, a vertical component of the taken motion vector is extracted as the vertical motion vector Vvct, and the extracted vertical motion vector Vvct is accumulated on the accumulation motion vector Vttl.

In a step S41, it is determined whether or not an absolute value of the accumulation motion vector Vttl is less than the threshold value Vth2, and in a step S43, it is determined whether or not the accumulation motion vector Httl is equal to or more than the threshold value Hth1. Furthermore, in a step S45, it is determined whether or not the accumulation motion vector Httl is equal to or more than the threshold value Hth2, and in a step S47, it is determined whether or not an absolute value of the accumulation motion vector Vttl is less than the threshold value Vth1.

When determined results of the steps S41, S53 and S45 are all YES, the process advances to a step S49. Furthermore, even when the determined result of the step S45 is NO, when the determined results of the steps S41, S43 and S47 are YES, the process advances to the step S49. On the one hand, if the determined result of the step S41 is YES and the determined result of the step S43 is NO, or if the determined results of the step S41 and S43 are YES and the determined results of the step S45 and S47 are NO, the process returns to the step S33. On the other hand, if the determined result of the step S41 is NO, the process advances to a step S69.

In the step S49, the still-image taking process which is similar to that in the above described step S15 is executed. Therefore, the Kth frame of image data is duplicated in the still-image area 34s. In a step S51, the accumulation motion vector Httl is set to the variable Hw_K, and in a step S53, the variable Hw_K and the accumulation motion vector Vttl are set to the Kth column of the register 30r. In a step S55, it is determined whether or not the variable K reaches “4”, and when a determined result is NO, the process advances to a step S57, while when the determined result is YES, the process proceeds to a step S63.

In the step S57, the strip image data ST_K is cut out from the Kth image data which is duplicated in the still-image area 34s. At this time, the cut out position is set to the center, and the cut out width is set to “Hw_K+A”. Upon completion of the process in the step S57, processes which are similar to those in the steps S29 to S31 are executed in steps S59 to S61, and thereafter, the process returns to the step S33.

In a step S63, the strip image data ST_K is cut out from the Kth image data which is duplicated in the still-image area 34s. At this time, the cut out position is set to the right end, and the cut out width is set to “Hw_K+A+{W−(Hw_K+A)}/2”. Upon completion of the process in the step S63, the panorama image creating process is executed in a step S65. In a step S67, the recording process is performed on the panorama image data which is created in the step S65. The panorama image data is recorded in the recording medium 40 in a file format. Upon completion of the recording process, the process returns to the step S3.

In a step S69, it is determined whether or not the variable K is equal to or more than “1”. If a determined result is YES, processes which are similar to those in the steps S65 to S67 are executed in steps S71 to S73, and thereafter, the process returns to the step S3. If the determined result is NO, the error process is executed in a step S75, and then, the process returns to the step S3.

As understood from the above description, a motion vector of the imaging surface is detected by the motion detecting circuit 44. The CPU 30 repeatedly accumulates the horizontal motion vector Hvct which is equivalent to a horizontal component of the detected motion vector so as to calculate the accumulation motion vector Httl (S37). The CPU 30 also repeatedly determines whether or not a movement of the imaging surface in the vertical direction satisfies a taking condition (=a condition under which an absolute value of the accumulation motion vector Vttl falls below the threshold value Vth1), in a period during which the accumulation motion vector Httl belongs to the predetermined range (a range from the threshold value Hth1 to the threshold value Hth2) (S43 to S47), and in parallel therewith, the CPU 30 repeatedly determines whether or not the accumulation motion vector Httl has reached the upper limit of the predetermined range (S45). If any one of the determined results is updated from NO to YES, the CPU 30 executes the still-image taking process for image composing (S49), and thereafter, restarts the process of calculating the accumulation motion vector Httl (S59).

By executing the still-image taking process when the movement of the imaging surface in the vertical direction satisfies the taking condition in the period during which the accumulation motion vector Httl belongs the predetermined range, it becomes possible to inhibit blurring of the still image in the vertical direction. Moreover, by executing the still-image taking process when the accumulation motion vector Httl has reached the upper limit of the predetermined range, it becomes possible to ensure continuity of a composed image in the horizontal direction. Thus, operability regarding creating the composed image is improved.

It is noted that, in this embodiment, a plurality of still images taken in parallel with an operation of panning the imaging surface are combined in the horizontal direction. However, a plurality of still images taken in parallel with an operation of tilting the imaging surface may be combined in the vertical direction.

Furthermore, in this embodiment, the digital camera is assumed as an image composing apparatus. However, the present invention is applicable to various electronic devices having an imaging function (mobile phone with camera, for example).

Moreover, a CCD type or CMOS type image sensor is applicable to the imaging device of this embodiment.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image composing apparatus, comprising:
a first accumulator which repeatedly accumulates a moving amount of an imaging surface in one direction of a horizontal direction and a vertical direction;
a first determiner which repeatedly determines whether or not a movement of said imaging surface in another direction of the horizontal direction and the vertical direction satisfies a taking condition, in a period during which an accumulated value of said first accumulator belongs to a predetermined range;
a second determiner which repeatedly determines whether or not the accumulated value of said first accumulator reaches an upper limit of the predetermined range, in parallel with a determining process of said first determiner;
a taker which takes, for image composing, a scene image produced on said imaging surface corresponding to updating from a negative result to a positive result on a determined result of said first determiner and/or a determined result of said second determiner; and
a restarter which restarts said first accumulator in association with a taking process of said taker.

2. An image composing apparatus according to claim 1, further comprising a second accumulator which accumulates the moving amount of said imaging surface in a direction noticed by said first determiner, wherein the taking condition includes a condition under which an accumulated value of said second accumulator falls below a reference.

3. An image composing apparatus according to claim 1, further comprising:
a cut-out processor which cuts out a part of scene image belonging to a designated area from the scene image taken by said taker; and
an adjuster which adjusts a size of the designated area in the direction noticed by said first determiner with reference to the accumulated value of said first accumulator at a time point of starting up said cut-out processor.

4. An image composing apparatus according to claim 3, wherein said adjuster increases the size of the designated area as the accumulated value of said first accumulator is increased.

5. An image composing apparatus according to claim 1, further comprising:
a creator which creates position information indicating a horizontal position and a vertical position of said imaging surface in association with the taking process of said taker; and
a composer which composes a plurality of scene images taken by said taker with reference to the position information created by said creator.

6. An image composing apparatus according to claim 5, further comprising:
a first starter which starts up said composer when the number of scene images taken by said taker reaches a designated value; and
a second starter which starts up said composer with reference to the number of scene images taken by said taker when the movement of said imaging surface in the direction noticed by said determiner matches an error condition.

7. A computer program embodied in a tangible medium which is executed by a processor of an image composing apparatus, comprising:
an accumulating instruction to repeatedly accumulate a moving amount of an imaging surface in one direction of a horizontal direction and a vertical direction;
a first determining instruction to repeatedly determine whether or not a movement of said imaging surface in another direction of the horizontal direction and the vertical direction satisfies a taking condition, in a period during which an accumulated value based on said accumulating instruction belongs to a predetermined range;
a second determining instruction to repeatedly determine whether or not the accumulated value based on said accumulating instruction reaches an upper limit of the predetermined range, in parallel with a determining process based on said first determining instruction;
a taking instruction to take, for image composing, a scene image produced on said imaging surface corresponding to updating from a negative result to a positive result on a determined result based on said first determining instruction and/or a determined result based on said second determining instruction; and
a restarting instruction to restart said first accumulator in association with a taking process based on said taking instruction.

8. An image composing method which is executed by an image composing apparatus, comprising:
a first accumulating step of repeatedly accumulating a moving amount of an imaging surface in one direction of a horizontal direction and a vertical direction;
a first determining step of repeatedly determining whether or not a movement of said imaging surface in another direction of the horizontal direction and the vertical direction satisfies a taking condition, in a period during which an accumulated value based on said first accumulator belongs to a predetermined range;
a second determining step of repeatedly determining whether or not the accumulated value based on said accumulating step reaches an upper limit of the predetermined range, in parallel with a determining process based on said first determining step;
a taking step of taking, for image composing, a scene image produced on said imaging surface corresponding to updating from a negative result to a positive result on a determined result based on said first determining step and/or a determined result based on said second determining step; and
a restarting step of restarting said accumulating step in association with a taking process based on said taking step.
